(19) United States
(12) Patent Application Publication
(10) Pub. No.: US 2013/0082527 A1
(43) Pub. Date: Apr. 4, 2013

(54) INTELLECTUAL SWITCH MODULE AND OPERATING METHOD FOR THE SAME

(71) Applicant: UNITECH ELECTRONICS CO., LTD., New Taipei City (TW)

(72) Inventors: Chun-Kai LIAO, New Taipei City (TW); Shang-Fang SHER, New Taipei City (TW)

(73) Assignee: UNITECH ELECTRONICS CO., LTD., New Taipei City (TW)

(21) Appl. No.: 13/644,512

(22) Filed: Oct. 4, 2012

(30) Foreign Application Priority Data
Oct. 4, 2011 (TW) 100135849

(51) Int. Cl. H02J 4/00

(52) U.S. Cl. 307/31

(57) ABSTRACT

A group includes plural switch modules (1). Anyone of the switch modules (1) can be chosen by a user as a main switch module at any time. The main switch module can be driven to enter a learning mode. In the meantime, the power status is detected by the switch module (1) in the group, and then a power status information (I1) is transmitted from the switch module (1) to the main switch module to record. A switch command (S1) is sent from the main switch module to the switch modules (1) in the group in accordance with the power status information (I1) recorded in the main switch module when the main switch module is operated to turn on a backup mode. Therefore, all of the switch modules (1) in the group are switched back to the statuses which are recorded in the learning mode.

This application is based on and claims the benefit of Taiwan Application No. 100135849 filed Oct. 04, 2011 the entire disclosure of which is incorporated by reference herein.

### BACKGROUND OF THE INVENTION

1. Field of the Invention

The present invention relates to a switch module, and especially relates to an intellectual switch module which is able to record the power statuses of all of the switch modules in a group.

2. Description of Prior Art

Generally speaking, switches are essential for a building. Electronic devices (for example, electric lamps or household appliances) in the building can be switched (turned on/off) easily by using switches. Therefore, switches are essential for daily livings.

To take the electric lamp for example, one electric lamp is usually controlled by one switch in the building to turn on or turn off. However, in a specific circumstance (for example, in a house), there are ten switches if there are ten electric lamps. The user needs to operate the ten switches respectively and personally to switch the ten electric lamps into required status (for example, five of the ten electric lamps are turned on and the remaining five electric lamps are turned off). It is very inconvenient for the users (especially for the elders or people who are inconvenient for walking) if the distances between the ten switches are too far or the quantity of the switches is much larger than ten.

Therefore, a controller which is connected to a plurality of switches to control the switches is commercially available. The controller is usually used in hotels, and the user can operate the controller to control these switches easily in the same time. Switches in a house can be controlled easily as well if the controller mentioned above is arranged in the house.

However, the controller mentioned above is usually fixed at one place in the house. It is still inconvenient because the user needs to walk to the place where the controller is fixed if the user wants to control the switches. Moreover, the manufacturing cost of the controller is high. It is a very high cost if a lot of the controllers are arranged in the house. Besides, the cost of the layouts of the connections between the controllers and the switches is required, and the construction for the layouts of the connections is troublesome.

Therefore, it is important to invent a kind of switch module that is able to control other switch modules through one switch module, and the layouts of the connections between the controllers and the switches will be eliminated.

### SUMMARY OF THE INVENTION

An object of the present invention is to provide an intellectual switch module and operating method for the same. Anyone of the switch modules in a group can be chosen as a main switch module to enter a learning mode to record power statuses of all of the switch modules in the group. All of the switch modules in the group are switched back to the statuses which are recorded in the learning mode when the main switch module is operated to turn on a backup mode. Moreover, every switch module is able to record at least one set of record of the power statuses of the switch modules in the group.

In order to achieve the object of the present invention mentioned above, the intellectual switch module includes a switch unit, a micro control unit, a power detecting and controlling unit, and a signal transceiver unit. A group includes a plurality of the switch modules. Anyone of the switch modules in the group can be chosen by a user as a main switch module at any time. The main switch module can be driven to enter a learning mode. In the meantime, the power status is detected by the switch module in the group, and then a power status information is transmitted from the switch modules to the main switch module to record. A switch command is sent from the main switch module to the switch modules in the group in accordance with the power status information recorded in the main switch unit when the main switch module is operated to turn on a backup mode. Therefore, all of the switch modules in the group are switched back to the statuses which are recorded in the learning mode.

The efficiency of the present invention is that the group includes a plurality of the switch modules, and anyone of the switch modules in the group can be chosen as the main switch module. The power status information of all of the switch modules in the group can be recorded in the main switch unit. The switch command is sent from the main switch unit to all of the switch modules in the group to switch the power statuses of the switch modules in the group. Moreover, every switch module in the group can be operated by the main switch module. In another word, every switch module in the group is able to control other switch modules actively, and is able to be controlled by other switch modules passively. Therefore, the intellectual switch module of the present invention is flexible for using and can increase the practicality of the switch module.

### BRIEF DESCRIPTION OF DRAWING

FIG. 1 shows a block diagram of a preferred embodiment of the present invention.

FIG. 2 shows a block diagram of an application for a preferred embodiment of the present invention.

FIG. 3 shows a diagram of the switch modules of the present invention and the electric lamps arranged in a room.

FIG. 4A shows a flow chart of a preferred embodiment of the present invention.

FIG. 4B shows a flow chart of another preferred embodiment of the present invention.

FIG. 5 shows a block diagram of another preferred embodiment of the present invention.

### DETAILED DESCRIPTION OF THE INVENTION

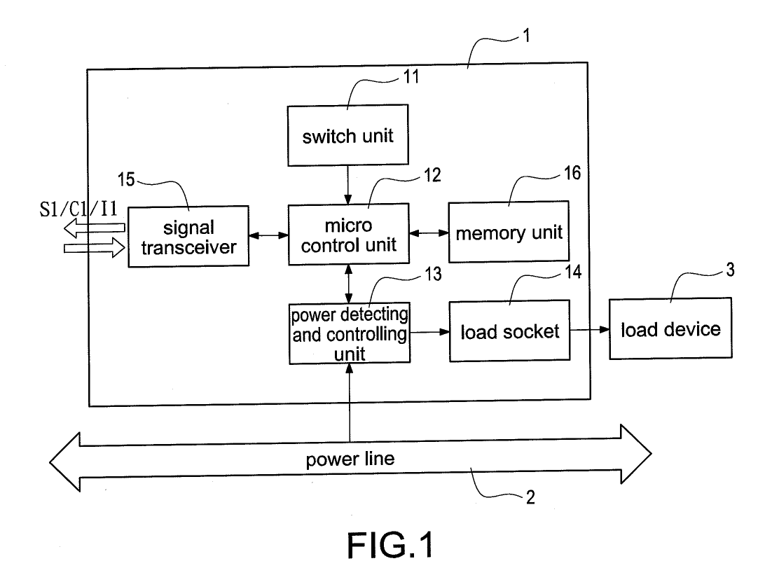

FIG. 1 shows a block diagram of a preferred embodiment of the present invention. The present invention is to provide an intellectual switch module 1. The intellectual switch module 1 will be referred to as switch module 1 in the contents afterwards for brevity. The switch module 1 is electrically connected to a power line 2 (for example, a power line of the wall socket power) and a load device 3 (for example, an electric lamp). The electric power is supplied to the load device 3 through the switch module 1 and the power line 2, so that the load device 3 can be operated (for example, turned on or turned off).

The switch module 1 mainly includes a switch unit 11, a micro control unit 12, a power detecting and controlling unit 13, a load socket 14, a signal transceiver 15, and a memory unit 16. The micro control unit 12 is electrically connected to the switch unit 11, the power detecting and controlling unit 13, the signal transceiver 15, and the memory unit 16. The load socket 14 is electrically connected to the power detecting and controlling unit 13. In this embodiment, the switch module 1 is connected to the load device 3 through the load socket 14. The load socket 14 is, for example, an electric lamp socket. The load device 3 is, for example, an electric lamp. Moreover, the load socket 14 is, for example, a power socket. The load device 3 is, for example, an electronic device connected to the switch module 1 through the power socket. The scope of the present invention is not limited to the examples mentioned above.

The micro control unit 12 is used to control the switch unit 11, the power detecting and controlling unit 13, the signal transceiver 15, and the memory unit 16, and is used to handle the signals and the data transmitted from the switch unit 11, the power detecting and controlling unit 13, the signal transceiver 15, and the memory unit 16.

The power detecting and controlling unit 13 is electrically connected to the power line 2. The power status of the switch module 1 is switched and detected by the power detecting and controlling unit 13. Moreover, the power statuses include cutting off and conducting. If the switch module 1 has the fine adjustment function, the power statuses further include the percentage of the electricity passing through the switch module 1 when the switch module 1 is conducted. The electricity supplied from the power line 2 is received by the load device 3 when the power status of the switch module 1 is conducted. Therefore, the load device 3 is activated (for example, the electric lamp is lighting, and the brightness of the electric lamp is controlled by the percentage of the electricity passing through). The electricity supplied from the power line 2 is not received by the load device 3 when the power status of the switch module 1 is cut off. Therefore, the load device 3 is not activated (for example, the electric lamp is not lighting).

In this embodiment, the switch unit 11 is, for example, a touch switch. According to the requirement, the switch unit 11 is, for example, a push-button switch, a toggle switch, a slide switch, or a mechanical switch as well. The switch unit 11 of the switch module 1 is controlled by a user to control the power detecting and controlling unit 13 and to switch the power status of the switch module 1. In another word, the switch unit 11 is controlled directly by the user to switch the power status of the switch module 1 as cutting off, conducting, or fine adjusting (changing) the percentage of the electricity passing through the switch module 1 to control the operation of the load device 3.

In this embodiment, a power status information I1 can be sent from the switch module 1 through the signal transceiver unit 15 to other switch modules 1. The power status information I1 of other switch modules 1 can be received by the switch modules 1 through the signal transceiver unit 15 as well. The power status information I1 is recorded in the memory unit 16 after the power status information I1 is handled by the micro control unit 12. Moreover, whether the power status of the switch power 1 is conducting or cutting off is recorded in the power status information I1. The percentage of the electricity passing through the switch module 1 is recorded in the power status information I1 as well if the power status is conducting.

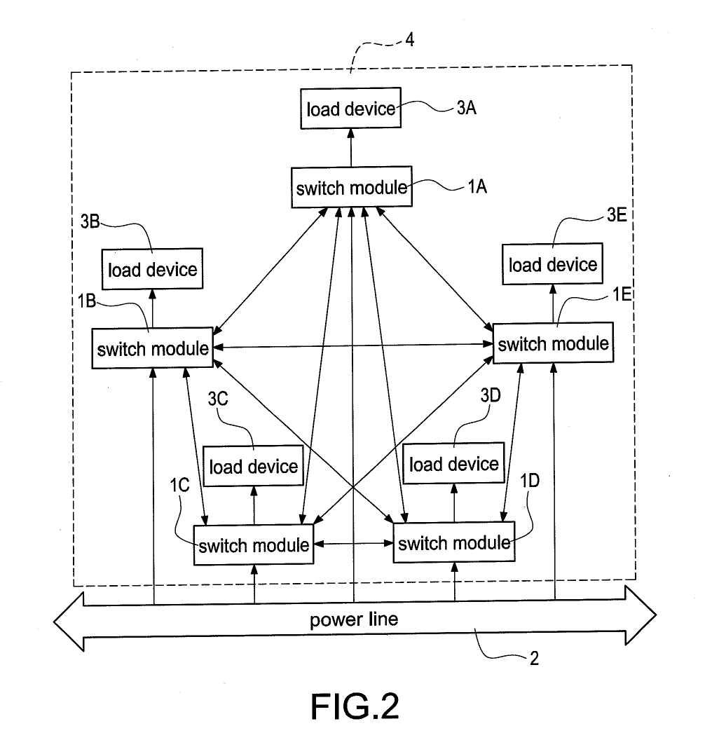

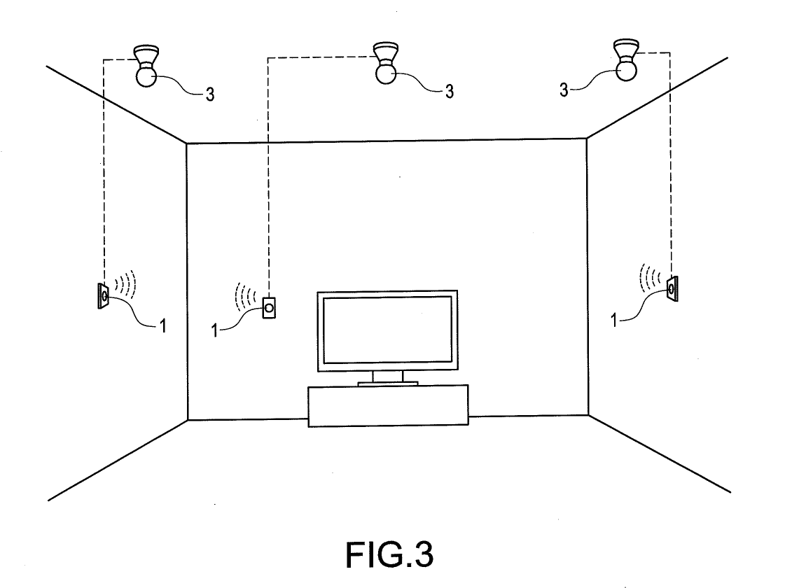

FIG. 2 shows a block diagram of an application for a preferred embodiment of the present invention. FIG. 3 shows a diagram of the switch modules of the present invention and the electric lamps arranged in a room. The single switch module 1 of the present invention is used to control and be electrically connected to the single load device 3. Moreover, in a specific circumstance (for example, in a house as shown in FIG. 3), a group includes a plurality of the switch modules 1. As shown in FIG. 2, a group 4 includes a plurality of the switch modules 1A, 1B, 1C, 1D, and 1E. Each of the load devices 3A, 3B, 3C, 3D, and 3E is controlled and electrically connected to the switch modules 1A, 1B, 1C, 1D, and 1E respectively.

The switch modules 1A, 1B, 1C, 1D, and 1E in the group 4 are electrically connected to each other with the Digital Addressable Lighting Interface (DALI) protocol for addressing. Therefore, the switch modules 1A, 1B, 1C, 1D, and 1E in the group 4 know the addresses of the switch modules 1A, 1B, 1C, 1D, and 1E in the group 4, so that commands and information can be transmitted (through the signal transceiver unit 15) between the switch modules 1A, 1B, 1C, 1D, and 1E in the group 4.

In this embodiment, the signal transceiver 15 is, for example, a Zigbee transceiver. Commands and information can be transmitted wirelessly from the switch module 1 through the signal transceiver 15 with Zigbee protocol and complying with DALI protocol. Moreover, the signal transceiver 15 can be other kinds of wireless transmission interface, such as Bluetooth or Wi-Fi. Commands and information can be transmitted from the switch module 1 through the power line 2 with DALI or Power Line Communication (PLC) interface. The scope of the present invention is not limited to the examples mentioned above.

Anyone of the switch modules 1 can be chosen by the user as a main switch module if the group 4 includes a plurality of the switch modules 1. The power statuses of the switch modules 1A, 1B, 1C, 1D, and 1E in the group 4 are detected by the switch modules 1A, 1B, 1C, 1D, and 1E respectively, and then the power status information I1 is generated and transmitted to the main switch module to record in the memory unit 16 when the main switch module is driven to enter a learning mode. Moreover, the power status information I1 recorded in the memory unit 16 includes the power status information I1 of the main switch module.

The switch modules 1A, 1B, 1C, 1D, and 1E can be controlled by the user respectively to control the action (turn on or off) of the load devices 3A, 3B, 3C, 3D, and 3E respectively. Moreover, the switch modules 1A, 1B, 1C, 1D, and 1E can be controlled by the user respectively to control the percentage of the electricity passing through to control the operation (for example, the brightness of the electric lamp) of the load devices 3A, 3B, 3C, 3D, and 3E respectively if the switch modules 1A, 1B, 1C, 1D, and 1E have fine adjustment function.

A switch commands S1 (as shown in FIG. 1) is sent from the main switch module to the switch modules 1A, 1B, 1C, 1D, and 1E in the group 4 in accordance with the power status information I1 recorded in the memory unit 16 when the main switch module is operated to turn on a backup mode. Therefore, the switch modules 1A, 1B, 1C, 1D, and 1E are switched back to the statuses which are recorded in the learning mode (including on status or off status, and if it is on status, further including the percentage of the electricity passing through). More specifically, the switch command S1 sent from the main switch module to the switch module 1A is in accordance with the power status information I1 sent from the switch module 1A in the learning mode. The switch command S1 sent from the main switch module to the switch module 1B is in accordance with the power status information I1 sent from the switch module 1B in the learning mode, and so on.

For example, the power statuses of the switch modules 1A, 1B are conducting (i.e. the load devices 3A, 3B are activated), and the power statuses of the switch modules 1C, 1D, 1E are cutting off (i.e. the load devices 3C, 3D, 3E are not activated) when the main switch module enters the learning mode. The power status information I1 is recorded in the memory unit 16 by the main switch module. After that, when the main switch module is operated to turn on the backup mode, the power statuses of the switch modules 1A, 1B will be conducting and the power statuses of the switch modules 1C, 1D, 1E will be cutting off, even if the power statuses of the switch modules 1A, 1B, 1C, 1D, 1E were cutting off (i.e. the load devices 3A, 3B, 3C, 3D, 3E were not activated) before the main switch module is operated to turn on the backup mode. In another word, the power statuses of the switch modules 1A, 1B, 1C, 1D, 1E in the group 4 are controlled simultaneously by the user with the main switch module. It is very convenient for the user.

For example, the power statuses of all of the switch modules 1 are cutting off and are recorded in the switch module 1 in the bedroom. The power statuses of all of the switch modules 1 will be cut off when the switch module 1 in the bedroom is operated to turn on the backup mode. In another word, all of the switch modules 1 are cut off easily and the user doesn't need to leave the bedroom to control all of the switch modules 1.

More particularly, anyone of the switch modules 1A, 1B, 1C, 1D, 1E in the group 4 can be chosen by the user as a main switch module (i.e. every switch module can be the main switch module, and there may be many main switch modules). The power status information I1 of the switch modules 1A, 1B, 1C, 1D, 1E recorded in the switch modules 1A may be different from that recorded in the switch modules 1B, and so on. Therefore, it is convenient and easy for the user to switch the switch modules 1A, 1B, 1C, 1D, 1E respectively in accordance with the power status information I1 recorded in different main switch modules.

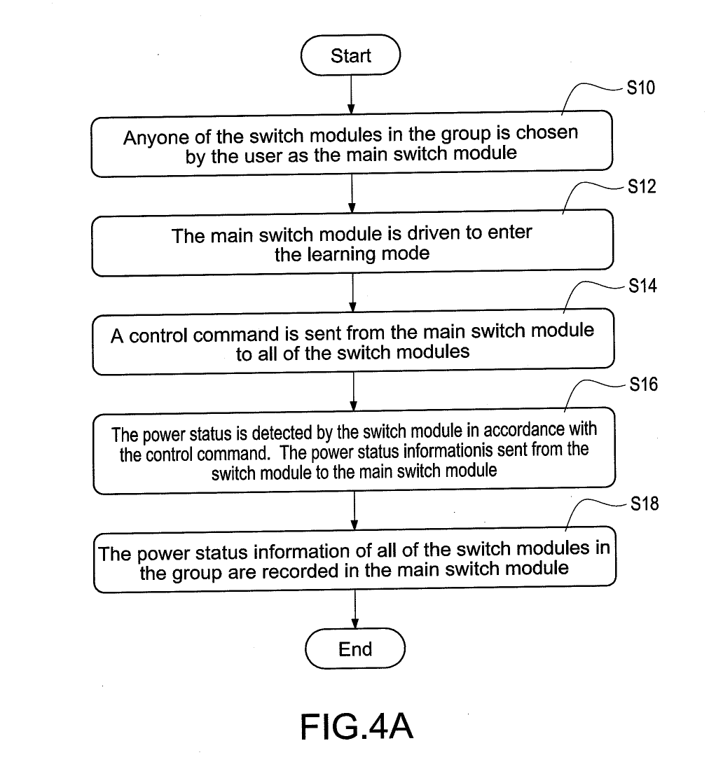

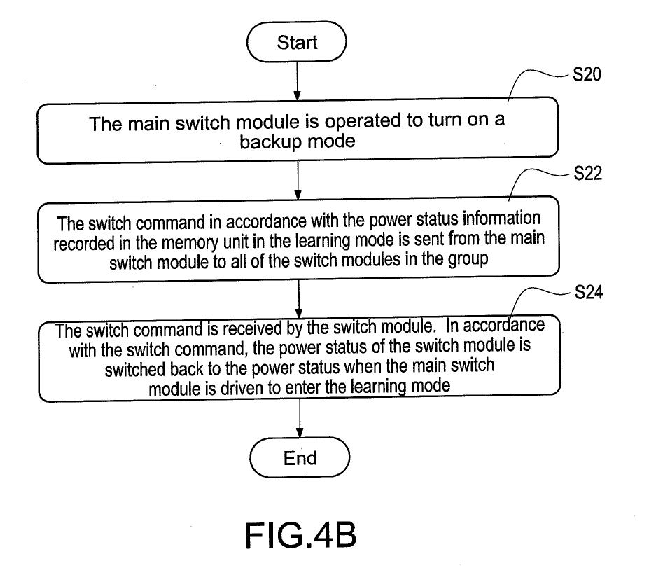

FIG. 4A shows a flow chart of a preferred embodiment of the present invention. Firstly, anyone of the switch modules 1 in the group 4 is chosen by the user as the main switch module (S10). Then, the main switch module is driven to enter the learning mode (S12). More specifically, in the step S12, the user operates the switch unit 11 (for example, the user presses the switch unit 11 three times successively), so that the main switch module is driven to enter the learning mode. The method mentioned above is just an example, and the scope of the present invention is not limited to it.

The power status information I1 sent from all of the switch modules 1 will be received and recorded by the main switch module when the main switch module is driven to enter the learning mode. More specifically, a control command C1 (as shown in FIG. 1) is sent from the main switch module to all of the switch modules 1 (S14) when the main switch module is driven to enter the learning mode. Then, the power status (conducting or cutting off, if it is conducting, further including the percentage of the electricity passing through the switch module 1) is detected by the switch module 1 in accordance with the control command C1. The power status information I1 is sent from the switch module 1 to the main switch module (S16). Finally, the power status information I1 of all of the switch modules 1 in the group 4 are recorded in the main switch module (S 18). After step 18, the power status information I1 of all of the switch modules 1 in the group 4 are recorded in the main switch module. The generating timing of the power status information I1 is the timing when the main switch module is driven to enter the learning mode.

FIG. 4B shows a flow chart of another preferred embodiment of the present invention. Firstly, the main switch module is operated to turn on a backup mode by the user (S20). More specifically, the user operates the switch unit 11 (for example, the user presses the switch unit 11 five times successively), so that the main switch module is operated to turn on the backup mode. The method mentioned above is just an example, and the scope of the present invention is not limited to it.

After step 20, the switch command S1 in accordance with the power status information I1 recorded in the memory unit 16 in the learning mode is sent from the main switch module to all of the switch modules 1 in the group 4 (S22). The switch command S1 is received by the switch module 1 through the signal transceiver unit 15. In accordance with the switch command S1, the power status of the switch module 1 is switched back to the power status when the main switch module is driven to enter the learning mode (S24).

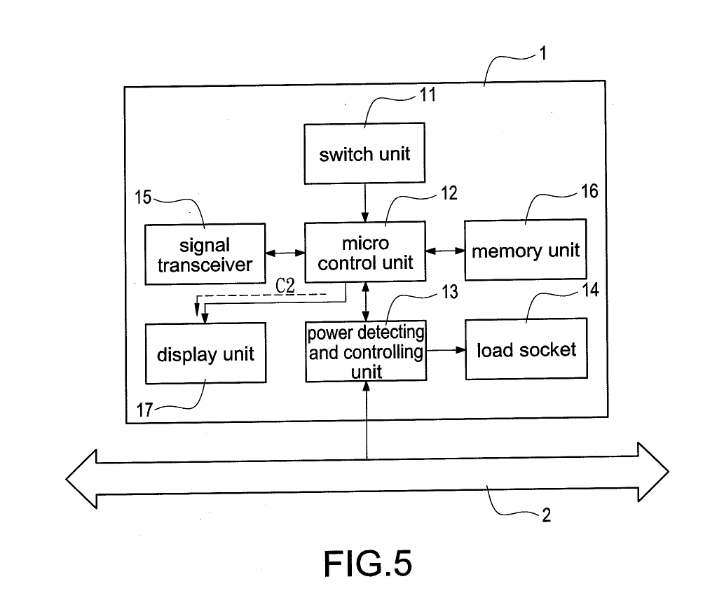

FIG. 5 shows a block diagram of another preferred embodiment of the present invention. In this embodiment, the switch module 1 further includes a display unit 17 electrically connected to the micro control unit 12. The display unit 17 is used to display the information of the switch module 1. For example, the user will know the power status and the electricity passing through the switch module 1 if the load device 3 (for example, an electric lamp) is electrically connected to the switch module 1. The display unit 17 displays the power status (conducting or cutting off, if conducting, further displaying the percentage of the electricity passing through) of the switch module 1 with lights or texts if the load device 3 is not electrically connected to the switch module 1. Moreover, the current consumption of the switch module 1 is detected by the power detecting and controlling unit 13 to generate an amperage information C2. The display unit 17 will display the amperage information C2. The use of electricity will be calculated by the switch module 1 in accordance with the amperage information C2, and will be displayed on the display unit 17. Therefore, the user will easily know the electricity consumption of the load device 3.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. An intellectual switch module (1) electrically connected to a power line (2) and a load device (3), the intellectual switch module (1) configured to convey an electric power from the power line (2) to the load device (3), the switch module (1) including:
a power detecting and controlling unit (13) electrically connected to the power line (2), the power detecting and controlling unit (13) configured to detect whether a power status is conducting or cutting off and to switch the power status and configured to detect a percentage of the electricity passing through the switch module (1) and to change the percentage of the electricity passing through the switch module (1);
a micro control unit (12) electrically connected to the power detecting and controlling unit (13);
a switch unit (11) electrically connected to the micro control unit (12), the switch unit (11) operated externally to control the power detecting and controlling unit (13) to switch the power status; and
a signal transceiver (15) electrically connected to the micro control unit (12), the signal transceiver (15) configured to transmit a power status information (I1) of the switch module (1) externally and receive the power status information (I1) sent from other switch modules (1),
wherein the power status information (I1) sent from all of other switch modules (1) in an area are received by the switch modules (1) when the switch modules (1) is driven externally to enter a learning mode; the power statuses of all of the switch modules (1) in the area are controlled by the switch module (1) in accordance with the power status information (I1) recorded in the switch unit (1) when the switch module (1) is operated externally to turn on a backup mode; the power statuses of all of the switch modules (1) in the area are switched back to the statuses which are recorded in the learning mode.

2. The intellectual switch module (1) in claim 1, wherein the switch modules (1) is configured to record the power status being conducting or cutting off in the power status information (I1), wherein the percentage of the electricity passing through the switch module (1) is further recorded in the power status information (I1) if the power status is conducting.

3. The intellectual switch module (1) in claim 1, wherein the switch unit (11) is a touch switch, a push-button switch, a toggle switch, or a slide switch.

4. The intellectual switch module (1) in claim 1, wherein the switch module (1) is electrically connected to other switch modules (1) with the digital addressable lighting interface protocol for addressing.

5. The intellectual switch module (1) in claim 4, wherein the signal transceiver unit (15) is a Zigbee transceiver; a control command (C1), a switch command (S1) and the power status information (I1) are transmitted wirelessly from the switch module (1) through the signal transceiver unit (15) with Zigbee protocol and complying with digital addressable lighting interface protocol.

6. The intellectual switch module (1) in claim 1, further including a load socket (14) electrically connected to the power detecting and controlling unit (13), wherein the switch module (1) is connected to the load device (3) through the load socket (14).

7. The intellectual switch module (1) in claim 6, wherein the load socket (14) is a power socket or an electric lamp socket.

8. The intellectual switch module (1) in claim 1, further including a memory unit (16) electrically connected to the micro control unit (12), wherein the memory unit (16) is configured to record the power statuses of all of the switch modules (1) in the area when the switch module (1) is driven to enter the learning mode.

9. The intellectual switch module (1) in claim 1, further including a display unit (17) electrically connected to the micro control unit (12), wherein the current consumption of the switch module (1) is detected by the power detecting and controlling unit (13) to generate an amperage information (C2); the display unit (17) displays the amperage information (C2) or the use of electricity calculated by the switch module (1) in accordance with the amperage information (C2).

10. An operating method for intellectual switch modules (1), the operating method applied to a group including a plurality of the switch modules (1), the operating method including:
a) choosing one of the switch modules (1) as a main switch module of the group;
b) receiving and recording a power status information I1 of all of the switch modules (1) in the group when the main switch module is driven to enter a learning mode; and
c) sending a switch command (S1) from the main switch module to the switch modules (1) in the group in accordance with the power status information (I1) recorded in the main switch module when the main switch module is operated to turn on a backup mode, wherein all of the switch modules (1) in the group are switched back to the statuses recorded in the learning mode.

11. The operating method for intellectual switch modules (1) in claim 10, wherein in the step b, a control command (C1) is sent from the main switch module to all of the switch modules (1) in the group, so that the power status is detected by the switch module (1) and the power status information (I1) is sent from the switch module (1) to the main switch module.

12. The operating method for intellectual switch modules (1) in claim 10, wherein the switch modules (1) are electrically connected to each other with the digital addressable lighting interface protocol for addressing.

13. The operating method for intellectual switch modules (1) in claim 12, wherein the control command (C1), the switch command (S1) and the power status information (I1) are transmitted wirelessly from the switch modules (1) with Zigbee protocol.

14. The operating method for intellectual switch modules (1) in claim 10, further including:
d) detecting the current consumption of the switch module (1) to generate an amperage information (C2); and
e) displaying the amperage information (C2) or the use of electricity calculated by the switch module (1) in accordance with the amperage information (C2) on a display unit (17) in the switch module (1).

15. The operating method for intellectual switch modules (1) in claim 10, wherein in the step b and c, a switch unit (11) in the main switch module is operated, so that the main switch module is driven to enter the learning mode and is operated to turn on the backup mode.
